(19) United States
(12) Patent Application Publication
(10) Pub. No.: US 2004/0117642 A1
(43) Pub. Date: Jun. 17, 2004

(54) Secure media card operation over an unsecured PCI bus

(76) Inventors: Keith R. Mowery, Plano, TX (US); Andrew Lueck, Plano, TX (US); Kevin Main, Plano, TX (US)

Correspondence Address: TEXAS INSTRUMENTS INCORPORATED, P O BOX 655474, M/S 3999, DALLAS, TX, 75265

(21) Appl. No.: 10/321,315

(22) Filed: Dec. 17, 2002

(51) Int. Cl. H04L 9/00

(52) U.S. Cl. 713/193

(57) ABSTRACT

A media card core is separated into a media encryption function decryption circuit which remains in hardware on the peripheral side of a PCI bus. The command function generator for the media card is separated and performed in the CPU. All information flow across the PCI bus is encrypted with the media encryption function or a second encryption function such as DES so as to impede access to the command structure or the data encrypted on the media card by unauthorized persons.

### CROSS REFERENCE TO RELATED APPLICATION

This application is related to co-pending commonly assigned application (TI docket T35253) entitled “Secure Driver” filed on even date herewith and incorporated herein by reference.

### FIELD OF THE INVENTION

The present invention is related to reading a media card over a unsecured computer bus and more specifically to a secure method for reading secure data from a FLASH media card over an unsecured PCI bus.

### BACKGROUND OF THE INVENTION

FLASH media cards are becoming a popular way of storing an exchanging information and this will increase as the price of the cards per megabit of memory continues to drop. It is thus economically fesible to distribute data such as audio or video recordings utilizing this media instead of using compact discs (CDs) or DVDs. The data stored on the media card would be encrypted utilizing an encryption function to prevent unauthorized access to the information.

FIG. 1 shows a block diagram of a conventional reader with FLASH media card generally as 100. The FLASH media card 122 has a key 124 stored within the memory thereon, shown schematically as a box on the card 122 in FIG. 1, which can be utilized to decrypt the information therein. The card 122 is plugged into FLASH media interface 120 which, in addition to providing a mechanical connection, provides the necessary data signals to and receives the necessary data signals from the FLASH media card. The FLASH media interface 120 communicates with a bus 118 to a FLASH media core 110. Stored within the FLASH media core 110 is a key 116 which can be utilized along with a decryption program diagrammatically shown as section 114 of FLASH media core 110. The key 116 and the decryption program 114 are utilized to decrypt the information stored on a FLASH media card. FLASH media core 110 also comprised section 112 which generates the commands to the FLASH media card to provide the data, for example, which has been decrypted and passed on to a user device. Those skilled in the art understand that the separation of the FLASH media core 110 into two sections 112, 114 is merely an illustrated tool to show the two functions, and in general, the circuits necessary for the two functions are not on an isolated portion of the chip, but may be dispersed therein and each may not occupy one half of the physical size of the chip. FLASH media core 110 communicates via bus 108 with a USB interface 106 which provides the necessary interface function to communicate to the host computer 102 via USB bus 104.

In operation, the host computer 102 requests data from the media card 122 via command over the USB bus 104 into the USB interface 106. The interface communicates the request via bus 108 to the section 112 of FLASH media core 110 which provides the command to the FLASH media card. The command is communicated via bus 118 to FLASH media interface 120 which communicates these commands to the FLASH media card 122. The FLASH media card will then provide encrypted data via the FLASH media interface 120 into the section 114 of the FLASH media core which does the decrypting. Prior to this operation taking place, the section 114 of the FLASH media core 110 has gone through an authentication and key change algorithm with the FLASH media card to identify itself as a proper receiver of the encrypted data to the media card and to set up a secure session. These encryption techniques are typically proprietary to a manufacture of the FLASH media card in order to protect the encrypted data that is distributed by means of the FLASH media card. Upon receipt of the encrypted data from FLASH media card, the circuits in section 114 of the FLASH media core 110 decrypt the data and send it to the USB interface 106 via bus 108. The USB interface 106 passes the data across USB bus 104 to the host computer 102 which can then process the data, or send it to an audio and/or a media card to generate an audio and/or video presentation.

There are two problems with this implementation of a reader for the FLASH media card 122. The first is that the FLASH media core chip 110 may be quite large and expensive to produce because it needs to have both the decryption function 114 and the control function 112 therein. It is therefore desirable to move the control functions for the FLASH media card to the host computer to utilize its memory and CPU in order to perform some of these functions without the necessity of additional circuitry.

A second problem with the prior art reader is that once the data is decrypted in FLASH media core 110, it is available at bus 108 or more easily at USB bus 104 for unauthorized use. It would therefore be desirable that unauthorized access into the data be prevented.

### SUMMARY OF THE INVENTION

It is the general object of the present invention to provide a media card reader in which the control functions are performed by the host computer. It is a second general object of the invention to provide a media card reader which timpedes unauthorized access to the decrypted information.

These and other objects and features are achieved in accordance with one aspect of the present invention by a read circuit for reading data stored on a media card utilizing a first encryption function. A computer has a CPU which communicates with peripheral devices via a bus. A first decryption circuit is coupled to the bus and to the media card for decrypting data stored on the media card utilizing the first encryption function. A second encryption/decryption circuit is coupled to the bus and the media card for encrypting data and decrypting commands sent on the bus utilizing a second encryption function. A driver stored within the computer instructs the CPU to generate the commands, encrypts the commands and decrypts the data encrypted utilizing the second encryption function.

Another aspect of the invention includes a read circuit for reading data encrypted on a media card utilizing a first encryption function and transmitting the data across a PCI bus. A secure transmission path comprises a second encryption/decryption circuit utilizing a second encryption function coupled to the bus and a driver for a CPU of a computer that communicates to peripherals across the bus, the driver encrypting commands utilizing the second encryption function for transmission across the bus and decrypting data encrypted utilizing the second encryption function received from the bus.

A further aspect of the invention comprises a method of secure transmission of data and commands across a peripheral bus. Data stored on a media card encrypted utilizing a first encryption function is transmitted across a peripheral bus in its encrypted state to a CPU. The encrypted data in its encrypted state is transmitted back across the bus to a media core circuit which decryptes the encrypted data to generate decrypted data. The decrypted data is reencrypted utilizing a second encryption function to generate reencrypted data. The reencrypted data is transmitted across the bus to the CPU.

Yet another aspect of the invention includes a method of reading data stored on a media card utilizing a first encryption function. Commands are transmitted to the media card encrypted utilizing a second encryption function across a computer bus for communicating with peripheral devices. The encrypted commands are decrypted to generate decrypted commands. The decrypted commands are transmitted to the media card. Data stored on the media card is transmitted in its encrypted state across the bus.

### BRIEF DESCRIPTION OF THE DRAWINGS

FIG. 1 shows a block diagram of a media card reader of the prior art;

FIG. 2 shows a block diagram of a media card reader in accordance with the present invention; and

FIG. 3 shows a flow chart of an authentication and key exchange algorithm for use with the present invention.

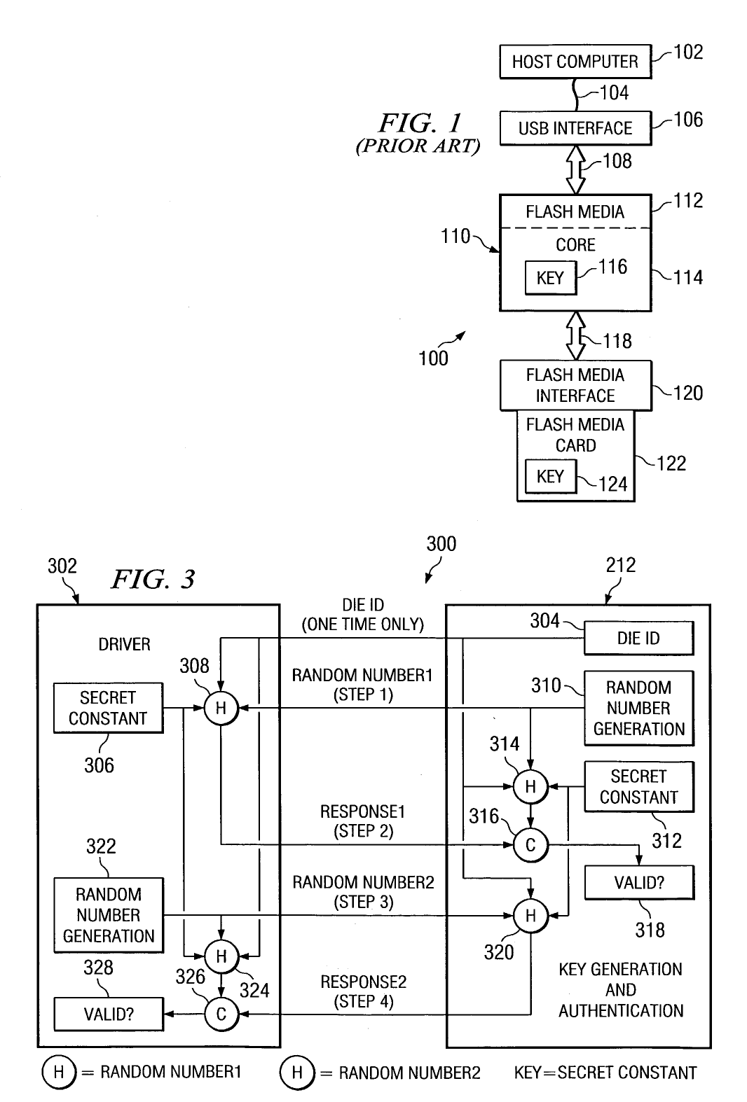

### DETAILED DESCRIPTION OF THE PRESENT INVENTION

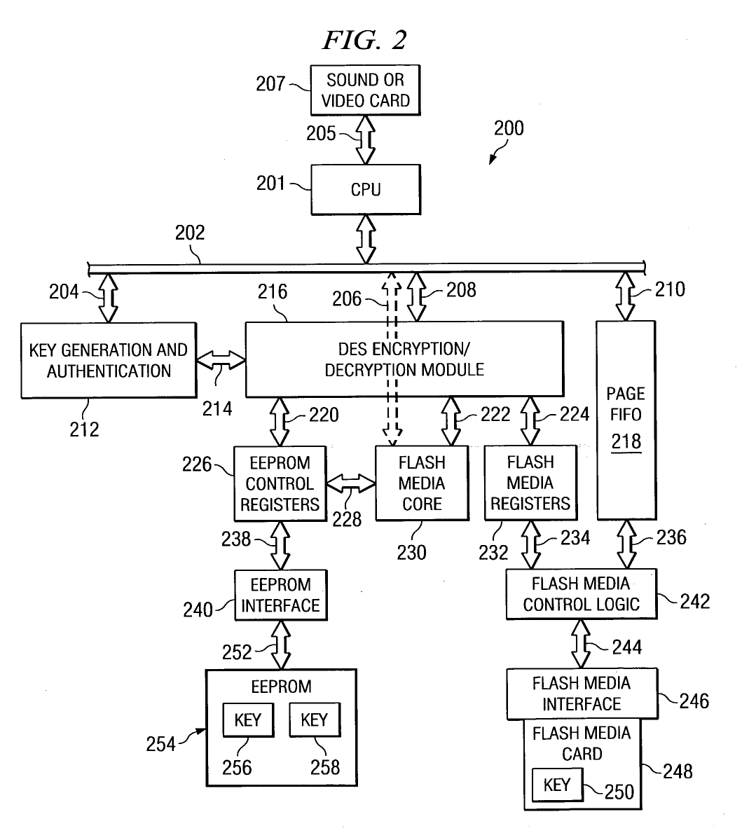

FIG. 2 shows a FLASH media card reader in accordance with the present invention generally as 200. The circuit 200 can generally be incorporated into a personal computer having a FLASH media reader card inserted into the PCI bus of the computer, as is well know in the art. The FLASH media card 248 can then be plugged into this card. The computer system includes a CPU 201 coupled to a sound or video card 207 via bus 205 and coupled to a PCI bus interface via two way bus 203. This portion of the drawing is simplified in that the “north bridge” and “south bridge” interface circuits which are generally used in such computer systems is not illustrated for simplicity, but are all well know to those skilled in the art. A more complete circuit diagram for implementing the present invention in the CPU 201 which contains a more detailed construction of the computer system is shown in co-pending application (T35253), filed even date herewith and incorporated herein by reference.

The PCI bus interface 202 is coupled by two way bus 204 to a key generation and authentication circuit 212. The PCI bus interface 202 is coupled by two way bus 208 to a DES encryption/decrypting module 216 and by two way bus 210 to page FIFO circuit 218. The key generation and authentication circuit 212 is connected to the DES encryption/decryption module 216 via two way bus 214. Two way bus 220 is coupled between DES encryption/decryption module 216 and EEPROM control registers 226, which in turn is coupled via two way bus 238 to EEPROM interface 240. The EEPROM interface 240 is coupled by two way bus 252 to EEPROM 254. EEPROM 254 contains two keys stored therein, diagrammatically illustrated as 256 and 258. Key 256 is used for the DES encryption/decryption. Key 258 is utilized by the FLASH media core to decrypt the data encrypted on the FLASH media card 248. It should be understood that some DES encryption functions do not require a key, so that key 256 may be omitted. In addition, the encryption utilized for the data on the FLASH media card may not require a key, so that key 258 may be omitted. The key 256 could also be stored in the key generation and authentication circuit 212 and the key 258 stored in the FLASH media core 230, but this makes changing the keys difficult. A FLASH media core 230 is coupled to the DES encryption/decryption module 216 via two way bus 222 and to the EEPROM controller registers 226 via two way bus 228. FLASH media core 230 may in the alternative be coupled via two way bus 206 directly to the PCI bus interface 202. FLASH media registers 232 are coupled to DES encryption/decryption module 216 via two way bus 224 and to the FLASH media control logic 242 via two way bus 234. FLASH media control logic is also coupled to the page FIFO circuit 218 via two way bus 236 and FLASH media interface 246 via two way bus 244. A FLASH media card 248 having a key stored therein, diagrammatically illustrated as 250, is plugged into the FLASH media interface 246.

A second path for encrypted data to flow from PCI bus interface 202 to FLASH media core 230 involves two way bus 206, which is shown in FIG. 2 in dotted lines to indicate that that is a option. In view of the fact that the data from the FLASH media card 248 is already encrypted, it is possible to avoid having the CPU 201 encrypt them using the DES encryption function and send the data received from the FLASH media card 248 to the FLASH media core by bypassing the DES encryption/decryption module 216.

In operation of the circuit 200, the CPU 201 generates the commands to operate the FLASH media card 248. These commands are generated by a computer program stored within a memory or hard drive of the computer (not shown) utilizing a driver such is that found in co-pending application (T35253). The commands have been encrypted using the DES encryption function which has been chosen for this system. As is well known to those skilled in the art, there are numerous encryption functions that meet the Data Encryption Standard (DES) for encrypted output. The choice of the particular encryption function is left to the designer as a trade off between the time required and the security provided. The encrypted command is transmitted across bus 203 to the PCI bus interface 202 and then transmitted across the PCI bus to bus 208 which couples the encrypted commands to the DES encryption/decryption module 216. In DES encryption/decryption module 216, the commands are decrypted utilizing a decryption function which matches the encryption function chosen. The decrypted command is sent via bus 224 to FLASH media registers 232. The registers in module 232 are utilized to configure the behavior of the FLASH media control logic, to initiate transactions and to indicate the status of the control logic and interface. The signals at the output of the registers are communicated via bus 234 to FLASH media control logic circuit 242 which generates the necessary control functions to perform desired commands. These signals are sent across bus 244 to the FLASH media interface 246 which contain the analog input/output buffers which communicate to the FLASH media card 248 via a FLASH media card connector in the interface (not shown). Before data stored on the FLASH media card 248 can be retrieved, the FLASH media card and the FLASH media core 230 must perform an authentication and key exchange procedure in order that each device authenticates the other and a key used to decrypt the information stored on the FLASH media card 248 is generated. The process of encryption, decryption and the authentication and key exchange between the FLASH media card 248 and the FLASH media core 230 is proprietary to the manufacture of the FLASH media card and is maintained secret in order to avoid a compromise in the security of the information stored on the card. The encrypted data from the FLASH media card 248 to the FLASH media core 230 pass through the FLASH media interface 246, over bus 244 to FLASH media control logic 242 which outputs it on bus 236 into the page FIFO module 218. Module 118 transmits it over bus 218 to the PCI bus interface 202 and then across bus 203 to the CPU 201, If the data can be sent across the PCI bus without further encryption because it is encrypted on the output of the FLASH media card 248. The CPU 201 receives the data and passes it back along bus 203, along one of two possible paths. In the first path, the data is encrypted using the DES encryption and passed along bus 203 to the PCI bus interface 202 and then along bus 208 to the DEC encryption/decryption module 216. The module 216 decrypts the command by removing the DES encryption, which does not effect the FLASH media encryption. The data, still encrypted with the FLASH media encryption is passed along by bus 222 to the FLASH media core 230. FLASH media core obtains the key 258 stored in EEPROM 254 via bus 252 to EEPROM interface 240. EEPROM interface 240 is coupled by two way bus 238 to the EEPROM control registers 226 and then by two way bus 228 to the FLASH media core. The FLASH media core utilizes the key 258 to perform an authentication and key exchange protocol with the FLASH media card 248 which will generate a session key permitting the two to send messages back and forth between them. Once the FLASH media core has generated a return command for the FLASH media card 248 it can be sent back to the CPU 201 via the first path utilizing buses 222, 208, 203 and via encryption/decryption module 216 and PCI bus interface 202. The CPU will send the command back over the PCI bus interface 202 via bus 203 and then to DES encryption/decryption module 216 which will decrypt the command. The decrypted command will be sent via bus 224 to FLASH memory registers 232. The outputs of the registers 232 are sent over bus 234 to FLASH media control logic circuit 242, and via bus 244 to FLASH media interface 246 and then to the FLASH media card 248. The FLASH media card 248 and FLASH media core 230 will exchange these commands until the authentication and key exchange protocol has been completed. This results in a session key which will allow them to work together.

Before the DES encryption/decryption module 216 can be utilized, it is necessary that the CPU 201 and the DES encryption/decryption module go through an authentication and key exchange routine as well. The authentication and key exchange is performed by module 212 and may use a key 256 stored in EEPROM 254 or may utilize an algorithm which is not involve the utilization of a key. This is explained below in detail in connection with FIG. 3.

If the CPU 201 wants to request data from the FLASH media card 248, the command will be sent to the FLASH media card as described above, and the FLASH media card will send encrypted data to the FLASH media interface 246, through bus 244 to FLASH media control logic 242 and through bus 236 to page FIFO circuit 218. The output of page FIFO circuit 218 is sent over bus 210, through PCI bus interface 202 and bus 203 to the CPU. The data encrypted with FLASH media card encryption function can either be encrypted with the DES encryption function and passed down to the FLASH media core using the path including buses 203, 208 and 222, PCI bus interface 202 and DES encryption/decryption module 216. However, since the data is already encrypted, the second encryption may not be used. In this case the data is sent via the optional path including buses 203 and 206 and PCI bus interface 202 to the FLASH media core 230. The FLASH media core 230 contains the FLASH media decryption algorithm which then decrypts the data so that the content may be utilized. Because the data is now free of all encryption, it is sent via bus 222 to DES encryption/decryption module 216 where it is reencrypted using the DES encryption function and sent along by PCI bus interface 202 and bus 203 to the CPU 201. In order to generate data, which is free from the FLASH media encryption by encrypting according to the DES encryption function, the CPU 201 decrypts the data to remove the DES encryption resulting in totally unencrypted data. The totally unencrypted data can be passed via bus 205 to a utilization means such as a sound and/or video card 207 to provide a sound output of the audio work stored on a card or a sound and video output of the audiovisual work found on the card.

It should be noted that at no time do commands or data move across the PCI bus without being encrypted by one or two encryption functions. This avoids the problems that unauthorized persons could monitor activities on the PCI bus and either obtain the commands utilized to operate the FLASH media card and thus bypass the protection on the card, or obtain the unencrypted output of the card and utilize the content without authentication.

An authentication and key generation procedure will now be described in connection with FIG. 3. As stated above, there are many procedures that are available to meet this requirement and the procedure described below is only an example and many other types of authentication and key exchange protocols could be substituted for the illustrated algorithm. In FIG. 3, the authentication and key exchange flow chart is generally shown as 300. Key generation and authentication circuits 212 generates a die ID at step 304, which could either be an identification number stored on the chip 212 or stored in EEPROM 254. This information is sent for the first time only to a hashing function 308 which is which is part of the driver 202, a portion of which resides in the CPU 201. The hashing function 308 also receives a secret constant or key 306 stored within the computer system (not shown) and the random number generated by random number generator 310 in circuit 212. These three numbers are utilized by the hashing function to produce an output which is coupled to comparison stage 316. Comparison stage 316 also receives the output of the hashing function 314, which is compared with the output from is the hashing function 308. Hashing function 314 also receives the die ID from 304 and the random number generator generated by random generator 310 as well as a secret constant 312 which is a key stored within the EEPROM 254 and shown as key 256. If the result of hashing functions 308 and 314 are identical, then the output of comparison stage 316 shows a valid authentication at 318. Circuit 212 now knows that driver function 302 is authenticated as a valid driver function for communications therewith. In addition, a hashing function 324 located in the driver 302 receives the output of the random generator 322 within the driver, the die ID 304 and the secret constant or key 306. The output of hashing function 324 is compared to the output of hashing function 320. In comparator phase 326. Hashing function 320 receives the die ID, and the secret constant 312 as well as the random number generated by random number generator 322. If the comparison at comparator 326 indicates that the output of hashing function 324 and 320 are identical, a valid authentication of the circuit 212 is found at 328. The driver and the key generation and authentication function 212 have now authenticated each other and it can now transmit a key for use during this session. This key utilized for the DES encryption/decryption as described above.

It is possible to send data from the CPU to the FLASH media card for storage. The unencrypted data is encrypted in the CPU, sent via bus 203 to the PCI bus interface 202, bus 208 to the DES encryption/decryption circuit 216. In circuit 216 the DES encryption is removed and the unencrypted data is sent to FLASH media core 230 via bus 222. FLASH media core 230 encrypts the data utilizing the FLASH media encryption function and sends the encrypted data to the CPU 201 via path 206, 202, 203 or 222, 216, 208, 202, 203. The encrypted data is then sent to the FLASH media card 248 via path 203, 202, 210, 218, 236, 242, 244, and 246 for storage.

While the invention has been particularly shown and described with reference to preferred embodiments, is well understood by those skilled in the art that various changes and modifications can be made in the invention without departing from the spirit and scope of the invention as defined by the appended claims. For example, DES encryption/decryption was chosen in the described examples. Other encryption/decryption techniques known in the art can be utilized in the present invention. In addition, the key generation and authentication circuit 212 is shown utilizing a key 256, but authentication processes are known in which a key is not utilized.

1. A read circuit for reading data stored on a media card utilizing a first encryption function comprising:
a computer having a CPU which communicates with peripheral devices via a bus;
first decryption circuit coupled to the bus and to the media card for decrypting data stored on the media card utilizing the first encryption function;
a second encryption/decryption circuit coupled to the bus and the media card for encrypting data and decrypting commands sent on the bus utilizing a second encryption function;
a driver stored within the computer for instructing the CPU to generate the commands, for encrypting the commands and for decrypting data encrypted utilizing the second encryption function.

2. The read circuit of claim 1 wherein the first decryption circuit is coupled to the bus via the second encryption/decryption circuit.

3. The read circuit of claim 1 wherein the first decryption circuit receives data from the media card encrypted utilizing the first encryption function via the CPU.

4. The read circuit of claim 3 wherein the decryption circuit is coupled to the bus via the second encryption/decryption circuit.

5. The read circuit of claim 1 wherein the bus is a PCI bus.

6. The read circuit of claim 2 wherein the bus is a PCI bus.

7. The read circuit of claim 4 wherein the bus is a PCI bus.

8. The read circuit of claim 1 wherein the second encryption function is DES.

9. The read circuit of claim 1 further comprising a control and interface circuit coupled between the media card and the PCI bus.

10. The read circuit of claim 1 wherein the second encryption/decryption circuit includes a key generation and authentication circuit.

11. The read circuit of claim 1 wherein the first decryption circuit includes a first encryption circuit for encrypting data from the CPU utilizing the first encryption function for recording on the media card.

12. The read circuit of claim 1 wherein the media card is a FLASH media card.

13. In a read circuit for reading data encrypted on a media card utilizing a first encryption function and for transmitting the data across a PCI bus, a secure transmission path comprising:
a second encryption/decryption circuit utilizing a second encryption function coupled to the PCI bus; and
a driver for a CPU of a computer that communicates to peripherals across the PCI bus, the driver encrypting commands utilizing the second encryption function for transmission across the PCI bus and decrypting data encrypted utilizing the second encryption function received from the PCI bus.

14. The secure transmission path of claim 13 further comprising an interface circuit coupled to a media card for transmitting data stored on the card utilizing a first encryption function across the PCI bus as encrypted data.

15. The secure transmission path of claim 13 wherein commands from the driver encrypted utilizing the second encryption function are decrypted in the second encryption/decryption circuit to instruct the media card to send data encrypted utilizing the first encryption function across the PCI bus.

16. The secure transmission path of claim 13 further comprising a media core circuit coupled to the second encryption/decryption circuit, the media core circuit decrypting data received from the PCI bus encrypted utilizing the first encryption function to generate decrypted data, the second encryption/decryption circuit encrypting the decrypted data utilizing the second encryption function for secure transmission across the PCI bus.

17. A method of secure transmission of data and commands across a peripheral bus comprising:
transmitting data stored on a media card encrypted utilizing a first encryption function across a peripheral bus in its encrypted state to a CPU;
transmitting the encrypted data in its encrypted state back across the bus to a media core circuit which decryptes the encrypted data to generate decrypted data;
reencrypting the decrypted data utilizing a second encryption function to generate reencrypted data;
transmitting the reencrypted data across the bus to the CPU.

18. The method of claim 14 further comprising:
decrypting the reencrypted data in the CPU to generate twice decrypted data;
transmitting the twice decrypted data to a utilization circuit.

19. A method of reading data stored on a media card utilizing a first encryption function comprising:
transmitting commands to the media card encrypted utilizing a second encryption function across a computer bus for communicating with peripheral devices;
decrypting the encrypted commands to generate decrypted commands;
transmitting the decrypted commands to the media card; and
transmitting data stored on the media card in its encrypted state across the bus.
